(19) United States
(12) Patent Application Publication
(10) Pub. No.: US 2011/0185409 A1
(43) Pub. Date: Jul. 28, 2011

(54) Authentication Method and System of At Least One Client Device with Limited Computational Capability

(75) Inventors: Hung-Yu Chien, Nantou (TW); Chi-Sung Laih, Tainan City (TW)

(73) Assignee: National Chi Nan University, Nantou (TW)

(21) Appl. No.: 12/817,307

(22) Filed: Jun. 17, 2010

(30) Foreign Application Priority Data
Jan. 22, 2010 (TW) 99101769

(51) Int. Cl. H04L 9/32; G06F 21/00

(52) U.S. Cl. 726/7

(57) ABSTRACT

An authentication method of a server device and at least one client device with limited computational capability includes randomly generating an initial codeword using the client device. The initial codeword is generated from a linear combination of at least one base. The base is assigned to the client device and selected from a generator matrix that is stored in the server device and that corresponds to a linear code.

The authentication method further includes generating an adapted codeword from the initial codeword using the client device. The authentication method also includes transmitting a transmission group to the server device using the client device. The transmission group includes an authentication data that includes the adapted codeword. In addition, the authentication method includes authenticating the client device using the server device and the transmission group received by the server device.

### CROSS REFERENCE TO RELATED APPLICATION

This application claims priority to Taiwanese application no. 99101769 filed on Jan. 22, 2010, which is herein incorporated by reference.

### BACKGROUND OF THE INVENTION

1. Field of the Invention

The invention relates to authentication technology, and more particularly to an authentication method and system of at least one client device with limited computational capability.

2. Description of the Related Art

Radio Frequency Identification (RFID) technology may be used in personal identification cards, such as for security system access control, electronic ticketing systems, medical history record management, or other applications. Conventional RFID authentication methods may permit an unauthenticated RFID reader to improperly access private information of an individual stored in an RFID tag.

Conventional RFID authentication methods may be based on Error Correction Code (ECC) technology and may permit tracing of an RFID tag. Conventional RFID authentication methods may also require computation of hash functions using specific algorithms that require a threshold amount of computing capability. As a result, such algorithms may be unusable with RFID tags that lack the threshold amount of computing capability, but are also lighter, and lower cost than other RFID tags.

### SUMMARY OF THE INVENTION

An object of the present invention is to provide an authentication method to overcome the disadvantages of conventional authentication methods and systems.

An authentication method of a server device and at least one client device with limited computational capability includes randomly generating an initial codeword using the client device. The initial codeword is generated from a linear combination of at least one base. The base is assigned to the client device and selected from a generator matrix that is stored in the server device and that corresponds to a linear code.

The authentication method further includes generating an adapted codeword from the initial codeword using the client device. The authentication method also includes transmitting a transmission group to the server device using the client device. The transmission group includes an authentication data that includes the adapted codeword.

In addition, the authentication method includes authenticating the client device using the server device and the transmission group received by the server device. Authenticating the client device includes decoding the adapted codeword of the authentication data according to the linear code to acquire an identification vector. Authenticating the client device also includes identifying the client device using the server device based on the identification vector and a base assignment data. Authenticating the client device further includes verification of the authentication data using the server device.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic block diagram of a radio frequency identification authentication system according to the preferred embodiment of the present invention;

FIG. 2 is a flowchart diagram illustrating steps for an initialization stage of the preferred embodiment; and

FIG. 3 is a flowchart diagram illustrating steps for an authentication stage of the preferred embodiment.

### DETAILED DESCRIPTION OF THE PREFERRED EMBODIMENT

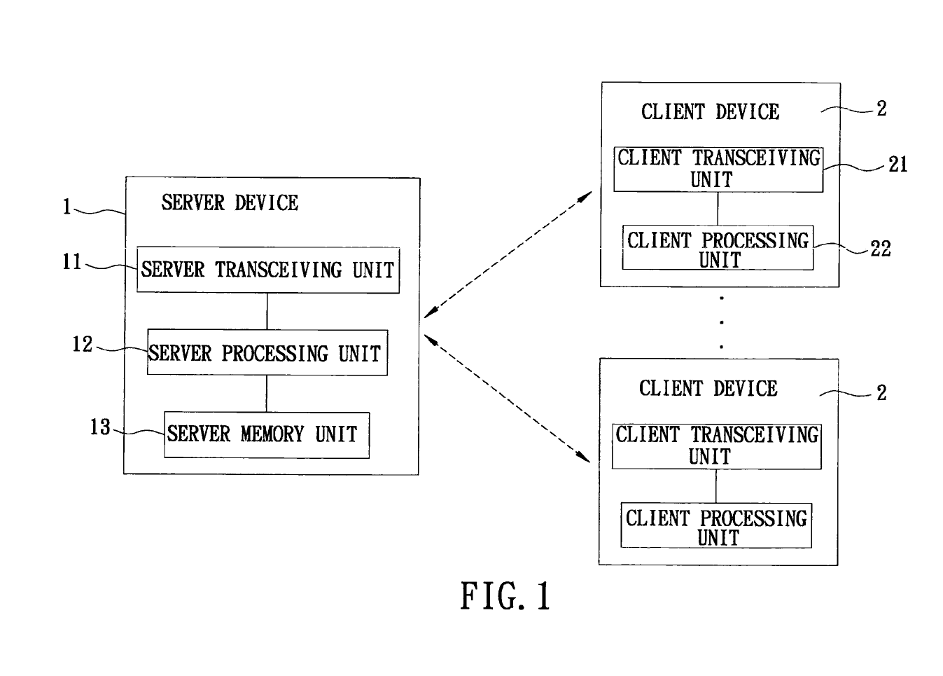

Referring to FIG. 1, the preferred embodiment of an authentication system according to the present invention is shown to include a server device 1 and at least one client device 2. The server device 1 includes a server transceiving unit 11, a server processing unit 12 connected to the server transceiving unit 11, and a server memory unit 13 connected to the server processing unit 12. Each of the client devices 2 includes a client transceiving unit 21 that performs communication with the server device 1, and a client processing unit 22 connected to the client transceiving unit 21.

In this embodiment, the authentication system is a Radio Frequency Identification (RFID) system with an authentication mechanism, in which the server transceiving unit 11 of the server device 1 is an RFID reader/writer, the server processing unit 12 of the server device 1 is a processor of a computer, and the server memory unit 13 of the server device 1 includes a physical storage medium, such as a hard drive. The server memory unit 13 may include a database. The client device 2 is an RFID electronic tag. The client transceiving unit 21 of the client device 2 is an antenna and the client processing unit 22 of the client device 2 is a processor chip. The client device 2 may lack resources to perform cryptographic functions such as one-way hashing, symmetric encryption, or a public key algorithm. The client device 2 may be limited to supporting functions such as a pseudo-random number generating function, addition, XOR, AND, OR, and Cyclic Redundancy Code (CRC) computation. The client device 2 may be passive.

The preferred embodiment of this invention may be used in any authentication system with a client device having limited computing capability as discussed above, and therefore is not limited to the disclosed RFID system application.

In order to more clearly describe the individual functionality of each component and the interaction among the components of the preferred embodiment of the foregoing authentication system, a preferred embodiment of an authentication method according to the present invention is described below. In FIG. 1, although a plurality of client devices 2 are illustrated, the present invention may also be applied to an authentication system having only one client device 2. Moreover, given that each client device 2 interacts with the server device 1 in the same manner, the operation between only one client device 2 and the server device 1 is described but may apply to additional client devices 2 in a similar manner.

Referring to FIGS. 1 to 3, the authentication method of this invention is shown to have two stages, including an initialization stage and an authentication stage.

### Initialization Stage

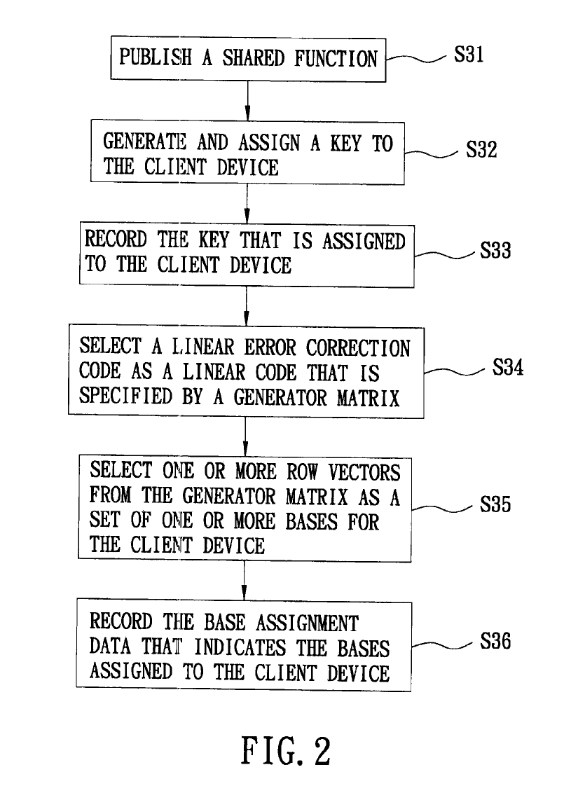

The initialization stage is executed once when the authentication system is established, and may be subsequently executed when the components of the authentication system are changed, such as when client devices 2 are added or removed. The initialization stage includes the steps as described below. The steps of the initialization stage are shown in FIG. 2.

In step S31, the server processing unit 12 publishes a shared function g( ) via the server transceiving unit 11, in which the shared function g( ) is a random number generating function used for generating an output parameter with a bit length (l_{g}) from an input parameter with a bit length (l_{g}), which is represented by the formula: g( ):{0,1}^{l}^{_{g}}→_{R}{0,1}^{l}^{_{g}}. In variations of the preferred embodiment, the shared function g( ) may be established rather than published by the server processing unit in step S31. The shared function g( ) may be published by being communicated to the client device 2 using alternate means of data transfer, such as a disk, a portable drive, or a network connection.

In step S32, the server processing unit 12 generates randomly a key (Kᵢ) where |Kᵢ|=l_{g}, and assigns the key (Kᵢ) to the client device 2 having an identity (Tᵢ).

In step S33, the server processing unit 12 records the key (Kᵢ) that is assigned to the client device 2 having the identity (Tᵢ) in the server memory unit 13.

In step S34, the server processing unit 12 randomly selects a linear error correction code as a linear code. The linear code is expanded over GF(2), and specified by a k×n generator matrix that is stored in the server memory unit 13. The linear code is represented by C(n,k,d), where (n) is a codeword length of the linear code, (k) is the length of the original data before encoding, and (d) is the minimum distance of the linear code. The generator matrix is represented by (G), and all the elements in the generator matrix belong to GF(2).

In step S35, the server processing unit 12 selects a quantity of (S) row vectors from the generator matrix as a set of bases for the client device 2 having an identity (Tᵢ), (S) being a number greater than or equal to 1. The (S) row vectors are selected in accordance with the following equation, in which G[j] represents the jth row vector in the generator matrix, and (i) may be an integer that corresponds to the client device 2 having an identity (Tᵢ): {G[j]|j=(i−1)×S+1, . . . , i×S}. Assuming that (l) is the number of the client devices 2 in the authentication system (e.g., l=|{Tᵢ}|), and that l|k, then S=k/l.

In step S36, the server processing unit 12 records the base assignment data in the server memory unit 13. The base assignment data includes the identity of the (S) row vectors in the generator matrix assigned to the client device 2 having an identity (Tᵢ). The (S) row vectors may be determined according to the equation: {G[j]|j=(i−1)×S+1, . . . , i×S}.

In variations of the preferred embodiment, one or more additional server devices may be used to perform each of the steps S31 through S36. Each of the additional server devices may include an additional processor, an additional memory, and an additional transceiver. The server device 1, the client device 2, and the additional server devices may communicate directly or through a network. The server device 1 and the additional server devices may share access to the server memory unit 13 or the additional memory of each of the additional server devices.

### Authentication Stage

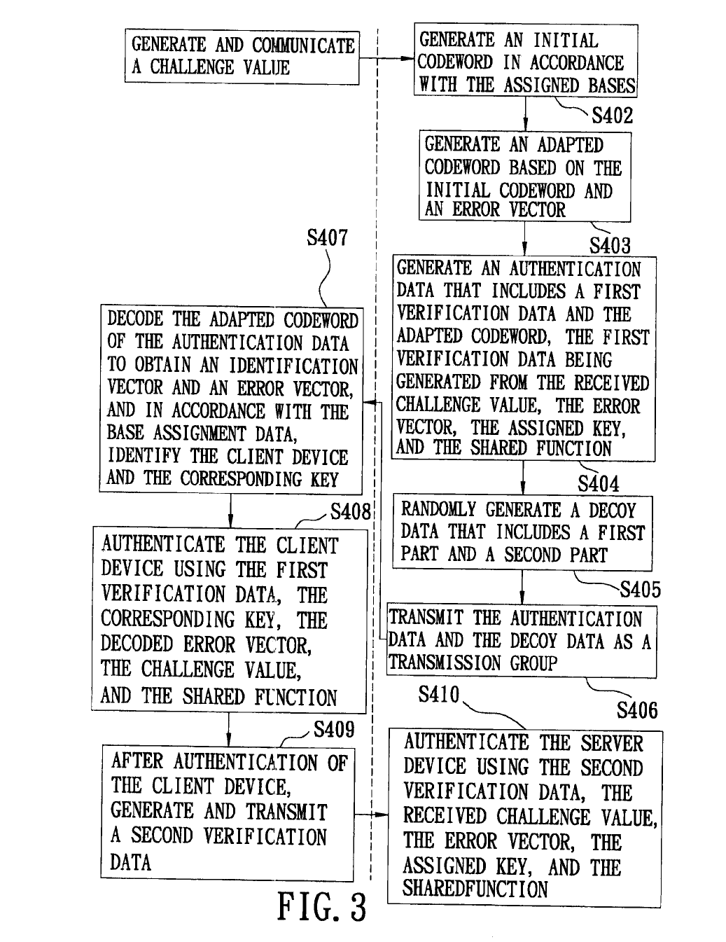

When the server device 1 detects the client device 2 using the server transceiving unit 11, then the authentication stage is initiated using the steps below. The steps of the authentication stage are shown in FIG. 3.

In step S401, the server processing unit 12 randomly generates a challenge value (N_{R}) where |N_{R}|=l_{g}, and sends a query message and the challenge value (N_{R}) to the client device 2 through the server transceiving unit 11.

In step S402, the client transceiving unit 21 of the client device 2 (Tᵢ) receives the query message and the challenge value (N_{R}). Next, the client processing unit 22 randomly generates an initial codeword (cᵢ) from a linear combination of the one or more assigned bases.

In step S403, the client processing unit 22 randomly generates an error vector (e), which has a Hamming weight smaller than or equal to └(d−1)/2┘. Next, the client processing unit 22 computes an adapted codeword (\tilde{c}ᵢ) using Formula (1) below:

\tilde{c}ᵢ=cᵢ+e (1)

In step S404, the client processing unit 22 generates an authentication data using a first verification data (\tilde{V}_{T}) and the adapted codeword (\tilde{c}ᵢ), with the first verification data (\tilde{V}_{T}) being determined from the received challenge value (N_{R}), the error vector (e) generated in step S403, the assigned key (Kᵢ), and the shared function g( ). The first verification data (\tilde{V}_{T}) is calculated using Formula (2) below. The adapted codeword (\tilde{c}ᵢ) generated in step S403 and the first verification data (\tilde{V}_{T}) are combined to form the authentication data, which is represented as (\tilde{c}ᵢ,\tilde{V}_{T}).

\tilde{V}_{T}=g(e′⊕g(N_{R}⊕Kᵢ)) (2)

When |e|=l_{g}, e′=e. Otherwise, the error vector (e) is used to obtain the adapted vector (e′) through string expansion or string shrinking calculations such that |e′|=l_{g}. Alternatively, the adapted vector (e′) is equal to the error vector (e) when |e|=|g(N_{R}⊕Kᵢ)|, and the error vector (e) is transformed to the adapted vector (e′) through string expansion or string shrinking such that |e′|=|g(N_{R}⊕Kᵢ)| when |e|≠|g(N_{R}⊕Kᵢ)|.

In step S405, the client processing unit 22 randomly generates a decoy data (ĉᵢ,\hat{V}_{T}) that includes a first part (ĉᵢ) and a second part (\hat{V}_{T}). |ĉᵢ|=|\tilde{c}ᵢ|, and |\hat{V}_{T}|=|\tilde{V}_{T}|, or in other words, the first part (ĉᵢ) is equal in length to the adapted codeword (\tilde{c}ᵢ), and the second part (\hat{V}_{T}) is equal in length to the first verification data (\tilde{V}_{T}).

In step S406, the client processing unit 22 sends the authentication data (\tilde{c}ᵢ,\tilde{V}_{T}) and the decoy data (ĉᵢ,\hat{V}_{T}) as a transmission group {(ĉᵢ,\hat{V}_{T}),(\tilde{c}ᵢ,\tilde{V}_{T})} to the server device 1 through the client transceiving unit 21. The transmitting order of the authentication data (\tilde{c}ᵢ,\tilde{V}_{T}) and the decoy data (ĉᵢ,\hat{V}_{T}) is randomly determined. By adding the decoy data (ĉᵢ,\hat{V}_{T}) and transmitting the authentication data (\tilde{c}ᵢ,\tilde{V}_{T}) and the decoy data (ĉᵢ,\hat{V}_{T}) in random order, the anonymity of the client device 2 having the identity (Tᵢ) is increased while traceability is decreased (e.g., untraceability is increased).

In step S407, the server transceiving unit 11 receives the authentication data (\tilde{c}ᵢ,\tilde{V}_{T}) and the decoy data (ĉᵢ,\hat{V}_{T}). Next, the server processing unit 12 decodes at least one of the adapted codeword (\tilde{c}ᵢ) of the authentication data (\tilde{c}ᵢ,\tilde{V}_{T}) and the first part (ĉᵢ) of the decoy data (ĉᵢ,\hat{V}_{T}) in accordance with the linear code to obtain an identification vector and an error vector (e) from the adapted codeword (\tilde{c}ᵢ). The identification vector is represented by (mᵢ). The initial codeword (cᵢ) generated by the foregoing step S402 relates to the generator matrix (G) and the parameter (mᵢ) as shown in the following Formula (3):

cᵢ=mᵢ*G (3)

where (mᵢ) is a vector having a length of (k) bits. If we let (p) be a bit index in (mᵢ) and 1≦p≦k, then for all pth bits in (mᵢ) for p∉(i−1)×S+1, . . . , i×S, the value is 0.

The server processing unit 12 identifies the client device 2 with identity (Tᵢ) and/or the key (Kᵢ) that corresponds to the client device 2 with identity (Tᵢ) using the identification vector and the base assignment data recorded in the server memory unit 13. The server processing unit 12 further retrieves the key (Kᵢ) corresponding to the client device 2 with identity (Tᵢ) from the server memory unit 13. The detailed operation for decoding the linear code in this step is not further described.

In step S408, the server processing unit 12 uses the first verification data acquired in step 407, the corresponding key (Kᵢ), the decoded error vector (e), the challenge value (N_{R}), and the shared function g( ) in the foregoing Formula (2) to perform authentication of the client device 1. If the equation of Formula (2) is satisfied, this indicates a successful authentication with respect to the client device 2 having identity (Tᵢ) by the server device 1.

In step S409, after authentication success in step 408, the server processing unit 12 generates a second verification data according to the challenge value (N_{R}) generated in step S401, the error vector (e) decoded in step S407, and the corresponding key (Kᵢ) acquired in step S407, and using the shared function g( ). The second verification data (Vₛ) is calculated using Formula (4) below. The server processing unit 12 sends the second verification data (Vₛ) to the client device 2 having identity (Tᵢ) via the server transceiving unit 12.

V_{S}=g(N_{R}⊕g(e′⊕Kᵢ)) (4)

In step S410, the client transceiving unit 21 of the client device 2 having identity (Tᵢ) receives the second verification data (Vₛ). Next, the client processing unit 22 uses the second verification data (Vₛ), the received challenge value (N_{R}), the error vector (e) generated in step S403, the assigned key (Kᵢ), and the shared function g( ) in the foregoing Formula (4) to perform authentication of the server device 1. If the equation of Formula (4) is satisfied, this indicates authentication success with respect to the server device 1 by the client device 2 having identity (Tᵢ).

After execution of steps S401 to S410, mutual authentication between the server device 1 and the client device 2 with identity (Tᵢ) is completed. Moreover, from the foregoing steps S402-S406 and step S410, it is evident that as long as the client processing unit 22 of the client device 2 has the computational capability for addition, exclusive-OR (XOR), and random number generation, then the preferred embodiment of the authentication method of this invention can be performed.

In variants of the preferred embodiment, the authentication method of this invention may be performed if the client processing unit 22 lacks the capability to perform one-way hashing, symmetric encryption, or public key algorithms. The method and system of the preferred embodiment may further be performed without synchronization between the server device 1 and the client device 2.

In summary, in the method and system of the preferred embodiment of this invention, client devices 2 with limited computational capability, such as lightweight RFID electronic tags, can be used to establish a mutual authentication mechanism with increased anonymity and reduced traceability. Therefore, the purpose of this invention is served.

While the preferred embodiment of the present invention and its variations have been described in connection with what is considered the most practical and preferred embodiment, it is understood that this invention is not limited to the disclosed embodiment and its variations but is intended to cover various arrangements included within the spirit and scope of the broadest interpretation to encompass all such modifications and equivalent arrangements.

What is claimed is:

1. An authentication method of a server device and at least one client device with limited computational capability, said authentication method comprising:
a) randomly generating an initial codeword using said client device, said initial codeword being generated from a linear combination of at least one base, said base being assigned to said client device and selected from a generator matrix that is stored in said server device and corresponds to a linear code;
b) generating an adapted codeword from said initial codeword using said client device;
c) transmitting a transmission group to said server device using said client device, said transmission group including an authentication data that includes said adapted codeword; and
d) authenticating said client device using said server device and said transmission group received by said server device, step d) including
d-1) decoding said adapted codeword of said authentication data according to said linear code to acquire an identification vector;
d-2) identifying said client device using said server device based on said identification vector and a base assignment data; and
d-3) authenticating said client device using said server device through verification of said authentication data.

2. The authentication method as claimed in claim 1, further comprising a step e) for initialization before step a), step e) including:
e-1) establishing a shared function;
e-2) assigning a key to said client device; and
e-3) storing said key that is assigned to said client device in a memory of said server device.

3. The authentication method as claimed in claim 2, wherein said server device publishes said shared function, assigns said key to said client device, and stores said key that is assigned to said client device in the memory of said server device.

4. The authentication method as claimed in claim 2, further comprising additional substeps of step e), including:
e-4) randomly selecting a linear error correction code using said server device to be said linear code, said linear error correction code being specified by said generator matrix with all elements belonging to GF(2);
e-5) assigning a row vector of said generator matrix to be said base for said client device; and
e-6) recording said base assignment data, said base assignment data including an identity of said base assigned to said client device.

5. The authentication method as claimed in claim 4, wherein said row vector is assigned using:
{G[j]|j=(i−1)×S+1, . . . , i×S}, G representing said generator matrix, G[j] representing a jth row vector of said generator matrix, S representing a quantity of rows of said generator matrix that are assigned to said client device, and i representing an identification number of said client device.

6. The authentication method as claimed in claim 1, further comprising a step f) before step c), including:
generating a first verification data using said client device for inclusion in said authentication data to be transmitted in step c), said first verification data being generated according to a shared function and a key assigned to said client device, said first verification data being included in said authentication data transmitted in step c).

7. The authentication method as claimed in claim 6, wherein said shared function is a random number generating function.

8. The authentication method as claimed in claim 6, wherein in substep d-2), said key of said client device is identified by said server device based on said identification vector and said base assignment data, and in substep d-3), said client device is authenticated by said server device using said first verification data and said key of said client device.

9. The authentication method as claimed in claim 6, further comprising a step g) before step c), including:
generating randomly a decoy data using said client device, said decoy data having a first part and a second part, said first part being equal in length to said adapted codeword, said second part being equal in length to said first verification data,
wherein said transmission group further includes said decoy data and is transmitted in step c) using a random transmission order of said authentication data and said decoy data.

10. The authentication method as claimed in claim 6, further comprising a step h) before step b), including:
generating an error vector using said client device, said error vector having a Hamming weight less than or equal to └(d−1)/2┘, d being a minimum distance of said linear code,
said adapted codeword in step b) being determined using \tilde{c}ᵢ=cᵢ+e, \tilde{c}ᵢ representing said adapted codeword, cᵢ representing said initial codeword, and e representing said error vector.

11. The authentication method as claimed in claim 10, further comprising a step aa) before step a), including:
aa-1) randomly generating a challenge value using said server device; and
aa-2) transmitting said challenge value to said client device,
wherein said first verification data is computed in step f) by said client device using \tilde{V}_{T}=g(e′⊕g(N_{R}⊕Kᵢ)), \tilde{V}_{T} representing said first verification data, g( ) representing said shared function, e′ representing an adapted vector, N_{R} representing said challenge value, Kᵢ representing said key, and |N_{R}|=|Kᵢ|,
said adapted vector being equal to said error vector when |e|=|g(N_{R}⊕Kᵢ)|, said error vector being transformed to said adapted vector through string expansion or string shrinking such that |e′|=|g(N_{R}⊕Kᵢ)| when |e|≠|g(N_{R}⊕Kᵢ)|.

12. The authentication method as claimed in claim 11, further comprising:
computing a second verification data using said server device after authenticating said client device;
transmitting said second verification data to be received by said client device;
receiving said second verification data using said client device; and
authenticating said server device using said client device, said error vector, said key, said second verification data, said challenge value, and said shared function.

13. An authentication system, comprising:
a client device with limited computational capability that includes
a client transceiving unit, and
a client processing unit coupled to said client transceiving unit and configured for randomly generating an initial codeword using a linear combination of at least one base, generating an adapted codeword from said initial codeword, and transmitting a transmission group, said base being assigned to said client device and selected from a generator matrix that corresponds to a linear code, said transmission group including an authentication data that includes said adapted codeword; and
a server device including
a server transceiving unit,
a server processing unit coupled to said server transceiving unit, and
a server memory unit coupled to said server processing unit and storing a generator matrix corresponding to a linear code,
said server processing unit being configured for receiving said transmission group, decoding said adapted codeword of said authentication data according to said linear code to acquire an identification vector, identifying said client device based on said identification vector and a base assignment data, and authenticating said client device through verification of said authentication data.

14. The authentication system as claimed in claim 13, wherein said server processing unit is configured for selecting said base from said generator matrix to assign to said client device, transmitting said base to said client device using said server transceiving unit, and recording said base assignment data in said server memory unit.

15. The authentication system as claimed in claim 13, wherein said client device is an electronic tag.

16. The authentication system as claimed in claim 13, wherein said server processing unit is configured for randomly selecting a linear error correction code to be said linear code, assigning at least one row vector of said generator matrix to be said base for said client device, and recording said base assignment data,
said base assignment data including an identity of said base assigned to said client device, said linear error correction code being specified by said generator matrix,
said row vector being assigned using {G[j]|j=(i−1)×S+1, . . . , i×S}, G representing said generator matrix, G[j] representing a jth row vector of said generator matrix, S representing a quantity of rows of said generator matrix that are assigned to said client device, and i representing an identification number of said client device.

17. The authentication system as claimed in claim 16, wherein said server processing unit is configured for publishing a shared function, assigning a key to said client device, and recording said key in said server memory unit using said server transceiving unit.

18. The authentication system as claimed in claim 13, wherein said client processing unit is configured for generating a first verification data according to a shared function and a key assigned to said client device, said first verification data being included in said authentication data for transmission using said client transceiving unit.

19. The authentication system as claimed in claim 18, wherein said server processing unit is configured for identifying said key of said client device based on said identification vector and said base assignment data, and authenticating said client device using said first verification data and said key of said client device.

20. The authentication system as claimed in claim 18, wherein said client processing unit of said client device is configured for generating randomly a decoy data that includes a first part and a second part, said first part being equal in length to said adapted codeword, said second part being equal in length to said first verification data, said transmission group further including said decoy data, said client processing unit being further configured for transmitting said transmission group using said client transceiving unit with a random transmission order of said authentication data and said decoy data.

21. The authentication system as claimed in claim 18, wherein said server processing unit is configured for computing a second verification data after authenticating said client device, and transmitting said second verification data to be received by said client device, said client device being configured for receiving said second verification data, and authenticating said server device using said client device, said key, said second verification data, and said shared function.

22. An electronic tag with limited computational capability configured for mutual authentication with a server device, said electronic tag comprising:
a transceiving unit for communication with the server device; and
a processing unit coupled to said transceiving unit for
randomly generating an initial codeword using a linear combination of at least one base,
generating an adapted codeword from said initial codeword,
generating a first verification data according to a shared function and a key assigned to said electronic tag, and
transmitting a transmission group that includes an authentication data including both said adapted codeword and said first verification data,
wherein said transmission group is transmitted to enable the server device to identify and authenticate said electronic tag.

23. The electronic tag as claimed in claim 22, wherein the server device stores said shared function, said key assigned to said electronic tag, said generator matrix corresponding to said linear code, and a base assignment data that includes an identity of said base assigned to said electronic tag, said base being selected from a row vector of a generator matrix that corresponds to a linear code, the server device being configured for publishing said shared function, assigning said key to said electronic tag, and selecting said base.

24. The electronic tag as claimed in claim 22, wherein said processing unit is configured for generating randomly a decoy data that includes a first part and a second part, said first part being equal in length to said adapted codeword, said second part being equal in length to said first verification data, said transmission group further including said decoy data, said processing unit being further configured for transmitting said transmission group using said transceiving unit with a random transmission order of said authentication data and said decoy data.

25. The electronic tag as claimed in claim 22, wherein said processing unit is configured for generating an error vector having a Hamming weight less than or equal to └(d−1)/2┘, and computing said adapted codeword using \tilde{c}ᵢ=cᵢ+e, d being a minimum distance of said linear code, e representing said error vector, \tilde{c}ᵢ representing said adapted codeword, cᵢ representing said initial codeword, and e representing said error vector.

26. The electronic tag as claimed in claim 25, wherein said processing unit is configured for computing said first verification data using \tilde{V}_{T}=g(e′⊕g(N_{R}⊕Kᵢ)), \tilde{V}_{T} representing said first verification data, g( ) representing said shared function, e′ representing an adapted vector, N_{R} representing a challenge value received by said electronic tag, Kᵢ representing said key, and |N_{R}|=|Kᵢ|, said adapted vector being equal to said error vector when |e|=|g(N_{R}⊕Kᵢ)|, said error vector being transformed to said adapted vector through string expansion or string shrinking such that |e′|=|g(N_{R}⊕Kᵢ)| when |e|≠|g(N_{R}⊕Kᵢ)|.

27. The electronic tag as claimed in claim 26, wherein said transceiving unit of said electronic tag is configured to receive a second verification data from the server device after the server device authenticates said electronic tag, said processing unit being configured to authenticate the server device using said error vector, said key, said second verification data, said challenge value, and said shared function.
